(19) United States
(12) Patent Application Publication
(10) Pub. No.: US 2010/0213697 A1
(43) Pub. Date: Aug. 26, 2010

(54) Adjustable Protective Cover Arrangement and Method

(76) Inventor: Anthony Francis England, Utrecht (NL)

Correspondence Address: THE WEBB LAW FIRM, P.C., 700 KOPPERS BUILDING, 436 SEVENTH AVENUE, PITTSBURGH, PA, 15219, US

(21) Appl. No.: 12/390,618

(22) Filed: Feb. 23, 2009

(51) Int. Cl. B42D 3/00

(52) U.S. Cl. 281/19.1

(57) ABSTRACT

The invention relates to a protective cover arrangement comprising a front cover, a back cover and a connecting member for connecting said front cover to the back cover, the connecting member being arranged to adjust the distance between the front cover and the back cover. The present invention provides for a robust protection system of modular design which is expandable and thus able to cover paperback and hardback books, magazines, journals, periodicals and related bound reading, writing and study materials of various height, width and thickness. This kind of protection system is particularly well suited to covering field and travel guides, maintenance manuals, school textbooks and any book that is subjected to being frequently moved or roughly handled.

### TECHNICAL FIELD

The present invention relates to protective covers, such as book covers. It also relates to a method of covering book-shaped media by means of such protective covers.

### STATE OF THE ART

Numerous different kinds of covers are currently employed to protect books. Most are of a comparatively simple design and constructed from either paper or thin flexible plastics. Naturally, due to wear and tear, the lifespan of such protectors is extremely limited. Due to their simple construction such covers can typically be adjusted somewhat to fit larger or smaller books, however, their low cost makes it both impractical and undesirable to reuse a semi-worn cover to protect a different book.

Other protectors made from more robust materials have also been constructed, however, these are only suitable to protect books of a predefined thickness.

With the obvious susceptibility of paperback books to the formation of ‘dog eared’ pages and accidental damage, it is desirable to have the cover give the kind of protection to the pages that the cover-leaves of a hardback book provide. No cover/protector has yet been known which satisfies such a specification.

### SUMMARY OF THE INVENTION

It is a goal of the present invention to provide a cover of variable thickness.

Therefore the invention relates to a protective cover arrangement, the arrangement comprising a front cover, a back cover and a connecting member for connecting said front cover to the back cover, the connecting member being arranged to adjust a distance between the front cover and the back cover.

The present invention provides for a robust protection system of modular design which is expandable and thus able to cover paperback and hardback books, magazines, journals, periodicals and related bound reading, writing and study materials of various height, width and thickness. This kind of protection system is particularly well suited to covering field and travel guides, maintenance manuals, school textbooks and any book that is subjected to being frequently moved or roughly handled.

In an embodiment the connecting member comprises one or more flexible elements, such as bands, threads, wires or strands.

In an embodiment the protective cover arrangement comprises at least one substantially rigid adjustment member movably arranged alongside said front and/or back cover, wherein said flexible elements are connectable to said adjustment members and/or an opposing cover.

According to a further embodiment the flexible elements and/or said adjustment member are connectable to said front cover and/or said back cover. In a particular embodiment Velcro tape is used to make the connection. Velcro tape is easy to fix and readjust.

In an embodiment the protective cover arrangement comprises one or more fixing members for fixing the adjustment member into a fixed position alongside the front or back cover. The fixing members may comprise releasable connecting means, such as Velcro tape. Other types of releasable connecting means could be used such as poppers, buttons, or buckles.

The front cover and back cover may comprise a relatively rigid material, such as rigid plastic, such as polypropylene.

In a particular embodiment the front cover and back cover have rectangular shapes. However, the covers may be made of any suitable shape or size. A specific example is the A4-format, which can be used to cover stacks of A4 paper.

In an embodiment the front cover or back cover or both comprise two panels. Between these panels, the adjustment member can be arranged.

In an embodiment the front cover and/or back cover comprise one or more openings for attaching the connecting member. The protective cover arrangement may also comprise a replaceable outer cover. The outer cover can be selected and varied to give the cover an attractive appearance while also protecting the book more effectively. The outer cover is typically made from a textile of one kind or another, and is also referred to as the outer fabric.

The invention also relates to a method of covering book-shaped media by means of an arrangement described above. The method comprises:

placing a front cover at a first side of the book-shaped media;

placing a back cover at a second side of the book-shaped media, opposite the first side;

connecting the front cover to the back cover by means of the connecting member;

adjusting the length of the connecting member.

### BRIEF DESCRIPTION OF DRAWINGS

Embodiments of the invention will now be described, by way of example only, with reference to the accompanying drawings in which corresponding reference symbols indicate corresponding parts, and in which:

FIG. 1 is an inside view (book side view) of the left and right panels of the unassembled inner most layer of the frame;

FIG. 2 is an outside view of the left and right panels of the unassembled outer most layer of the frame;

FIG. 3 is a view of a thickness adjuster according to an embodiment;

FIG. 4 schematically shows a front (left side) and back (right side) book cover-leaf holder;

FIG. 5 is a schematic representation of how the components of the frame, cover-leaf holders and spine support bands are assembled according to an embodiment;

FIG. 6 is an inside view of the assembled inner frame, according to an embodiment, also showing six spine support bands;

FIG. 7 is an outside view of the assembled outer frame;

FIG. 8 schematically shows the placement of the cover-leaf holders on the inner frame;

FIG. 9 schematically shows cover-leaf holders on the inner frame according to another embodiment;

FIG. 10 schematically shows the possible movement of the thickness adjuster inside one of the covers;

FIG. 11 shows the inside of a representative outer cover according to an embodiment;

FIG. 12 shows the frame (i.e. the cover panels with the connecting member) and a representative replaceable outer cover prior to final assembly.

### DETAILED DESCRIPTION OF THE EMBODIMENTS

According to an embodiment, a protective arrangement comprises a front cover and a back cover connected by a connecting member. The connecting member is arranged to adjust a distance between the front and back cover, and is also referred to as the thickness adjustment mechanism. In an embodiment, each of the front and back covers consists of two rectangular panels of a thin sheet of a comparatively rigid plastic, such as polypropylene.

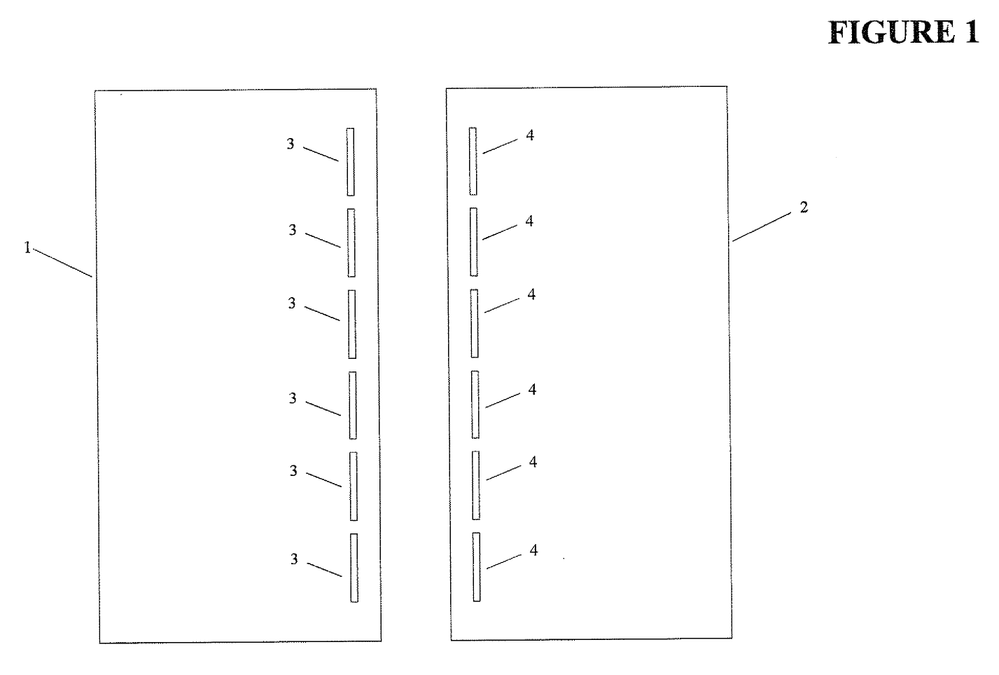

FIG. 1 shows two inner panels 1,2 comprising slits 3,4 made in the panels 1,2 respectively.

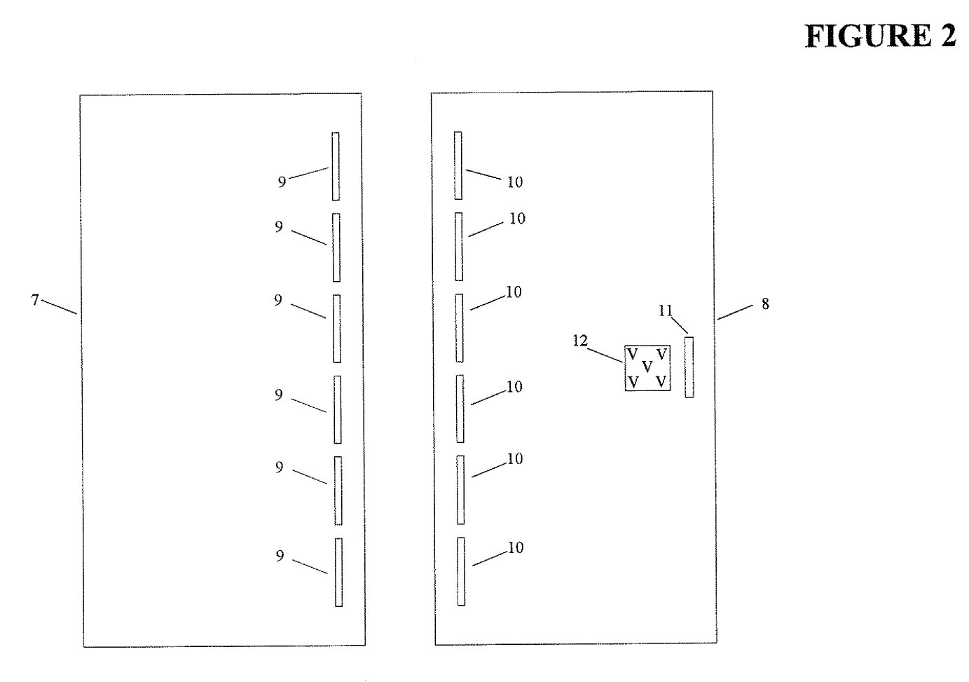

FIG. 2 shows two outer panels 7,8, which are very similar in design to the inner panels 1,2. The outer panel 8 comprises, next to a plurality of slits 10, an additional slit 11 and a Velcro-type attachment strip 12, onto which an adjuster ribbon may be secured, as will be explained below. In the Figures, the Velcro-type strips are depicted using the character ‘V’.

In an embodiment, the connecting member comprises a thickness adjuster between two panels of the front or back cover. It is noted that a second thickness adjuster can be present inside the other cover.

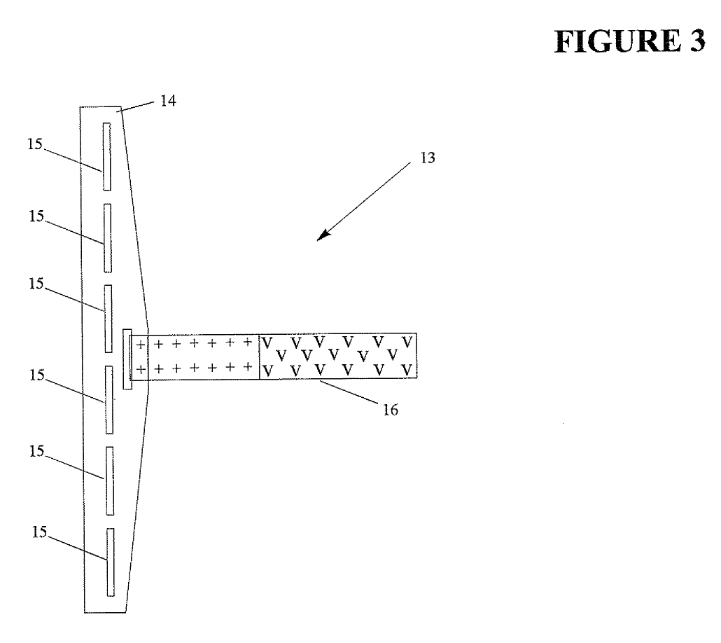

FIG. 3 illustrates a thickness adjuster 13 comprising am adjustment member 14 made out of e.g. rigid polypropylene. The adjustment member 14 comprises slits 15 for passing through so-called ‘spine support bands’, not shown in FIG. 3. Furthermore, the thickness adjuster 13 comprises a ribbon 16, typically of a thin dressmaker's ribbon, which will ultimately be secured to the attachment strip 12 at the outer panel 8, see FIG. 2. It is noted that the invention is not limited to covers with two walls (panels). In case the covers are single-wall covers, a thickness adjuster can be arranged on any side of the cover.

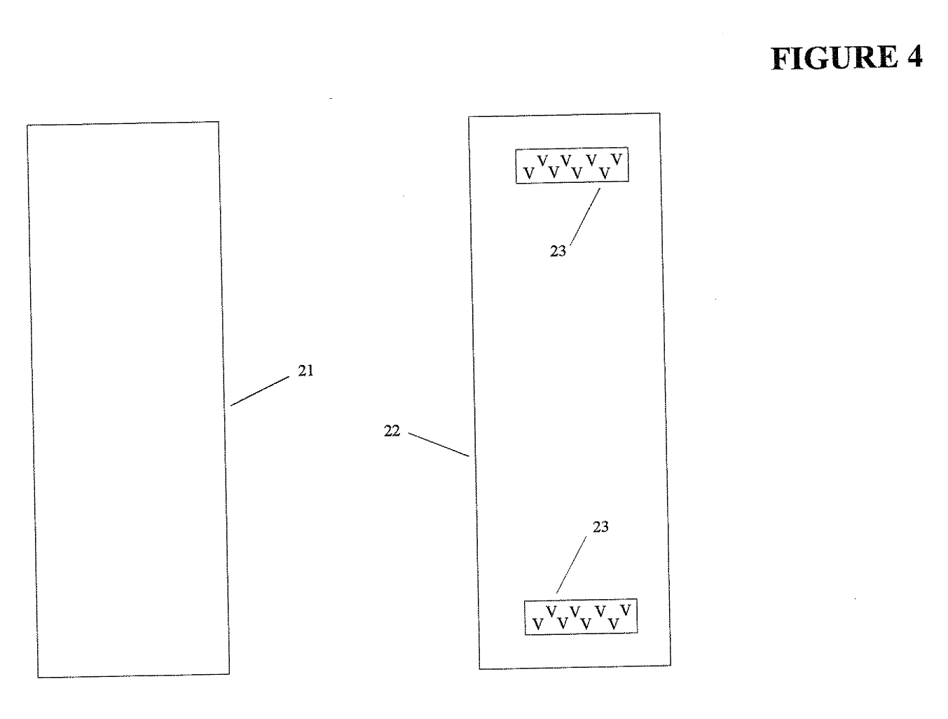

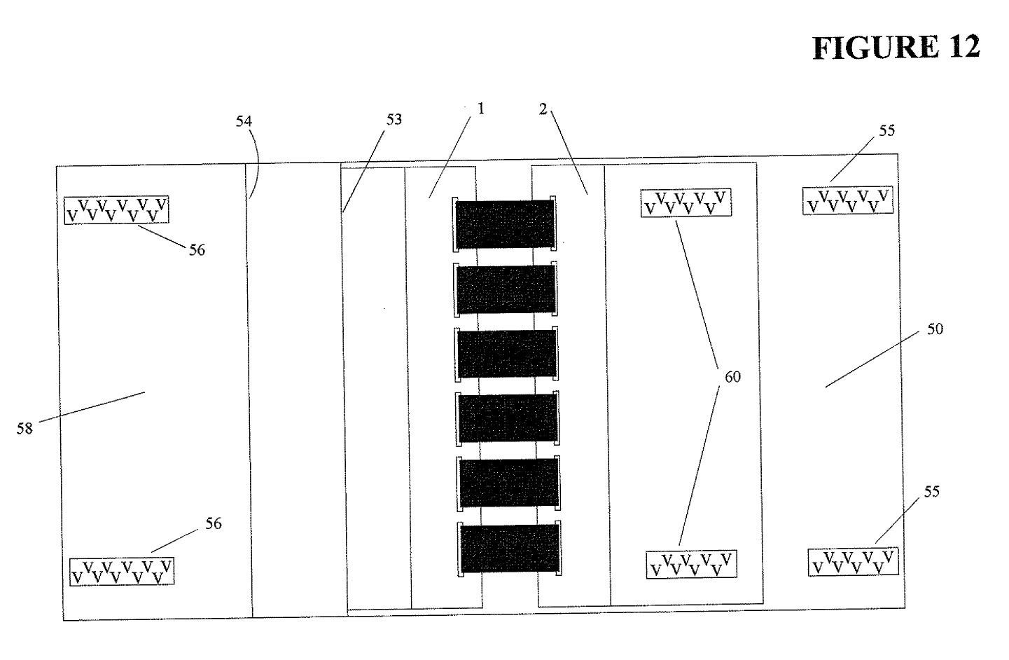

FIG. 4 illustrates a front and back cover-leaf holder 21,22, for example made from a thin but strong transparent plastic film, which holds the book in place in the cover arrangement according to an embodiment. Both holders 21,22 are the same height as the inner and outer cover panels 1,2,7,8, but are narrower, to allow for easy insertion of the book's cover-leaves. In this example, the back cover-leaf pocket also has a Velcro-type attachment point 23 which is used to attach an outer cover to the right side of the inner frame, as will be explained with reference to FIG. 12.

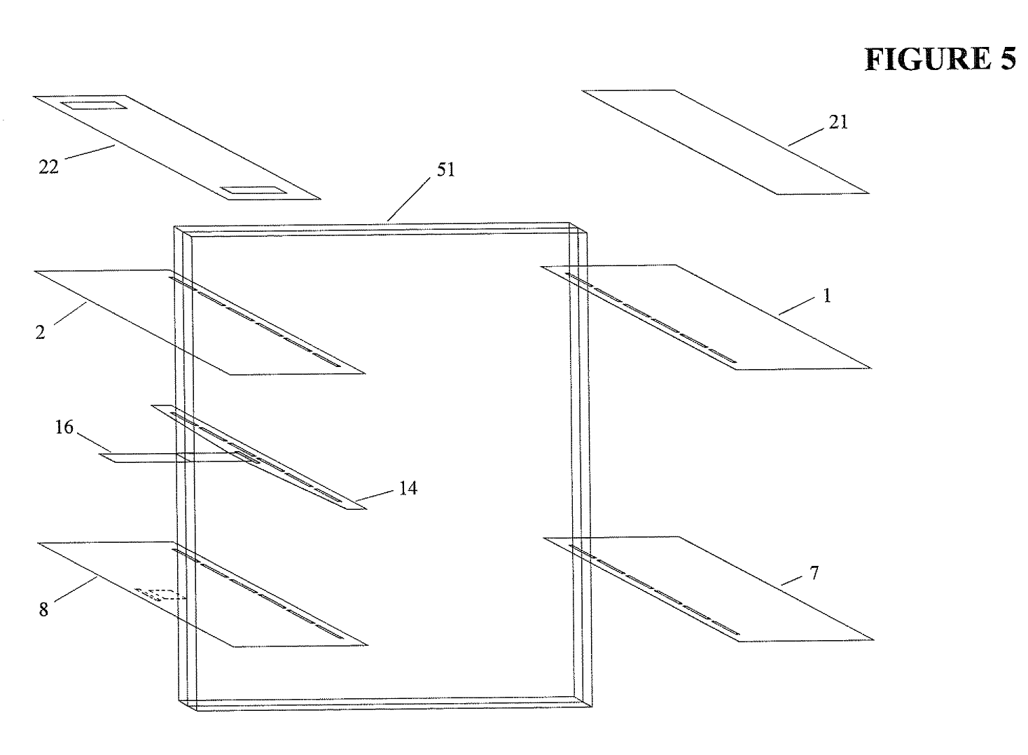

The major components of the protective arrangement come together in FIG. 5, wherein the various panels described above are assembled around six flexible spine support bands 51, of which only one is shown. In FIG. 5, the length of the band 51 is greatly exaggerated in order to illustrate how assembly is accomplished.

For a typical book sized specification, with cover panels of height equal to 235 mm and width equal to 125 mm, the spine support bands 51 may be approximately 230 mm in length. The flat support bands 51 can be made from a woven synthetic ribbon (of typically 25 mm in width) in which the ends are stitched, welded, or otherwise joined together to complete a circle. It is however noted that all kinds of flexible materials can be used, and that the spine support bands do not need to be circular. In this embodiment of the invention the outer panels 7,8 effectively act as a protective cover for the adjustment mechanism, i.e. the thickness adjuster 13.

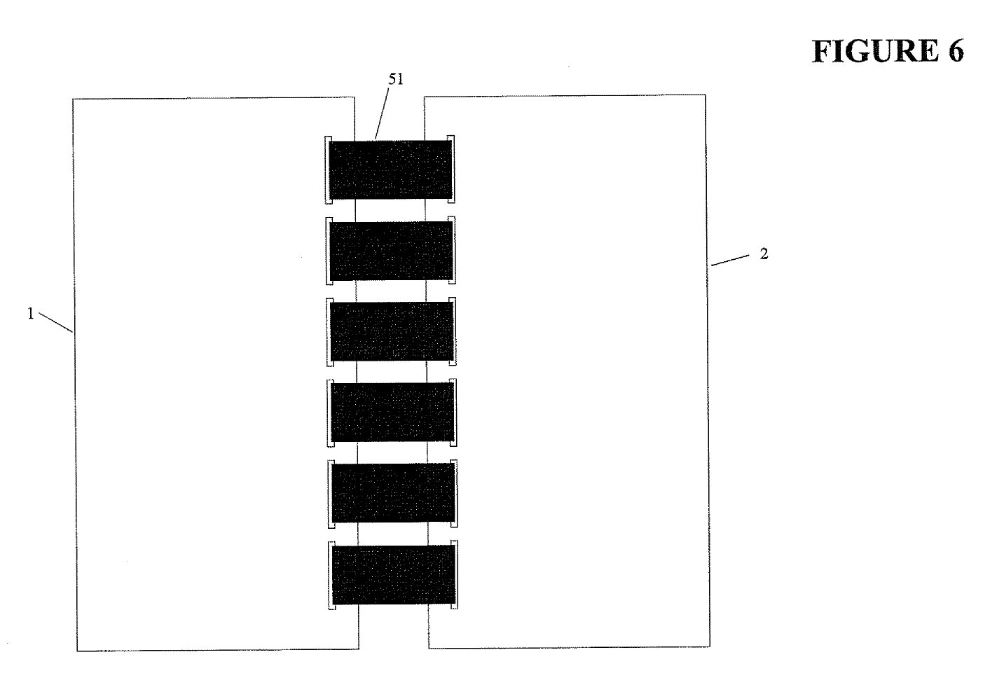

FIG. 6 illustrates the appearance of the inside of the cover arrangement once all six spine support bands 51 have been inserted and configured to hold a packet of paper, such as a book. In FIG. 6, the thickness adjuster 13 is not visible. The spine support bands 51 form a flexible bridge between the two rigid halves of the total arrangement.

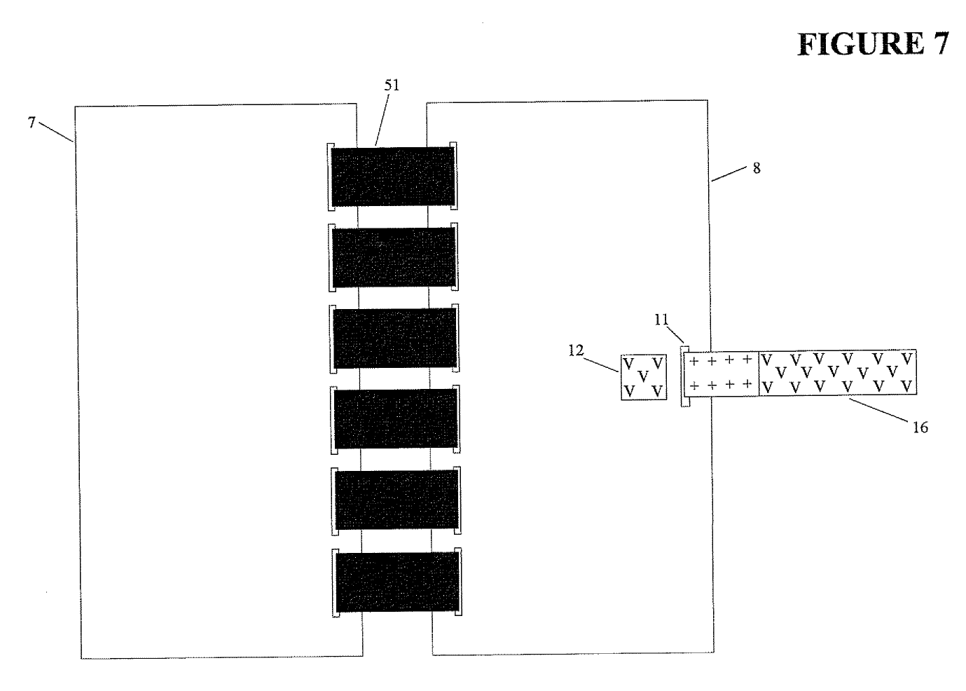

FIG. 7 illustrates the appearance of the outer side of the cover arrangement, with particular reference to the positioning of the thickness adjuster ribbon 16. The ribbon 16 exits the right cover via the slit 11 where it is secured at the adjacent Velcro-type attachment 12, thereby holding the thickness adjustment member inside the cover in place. In this way a specific thickness, i.e. a distance between the two covers, is defined.

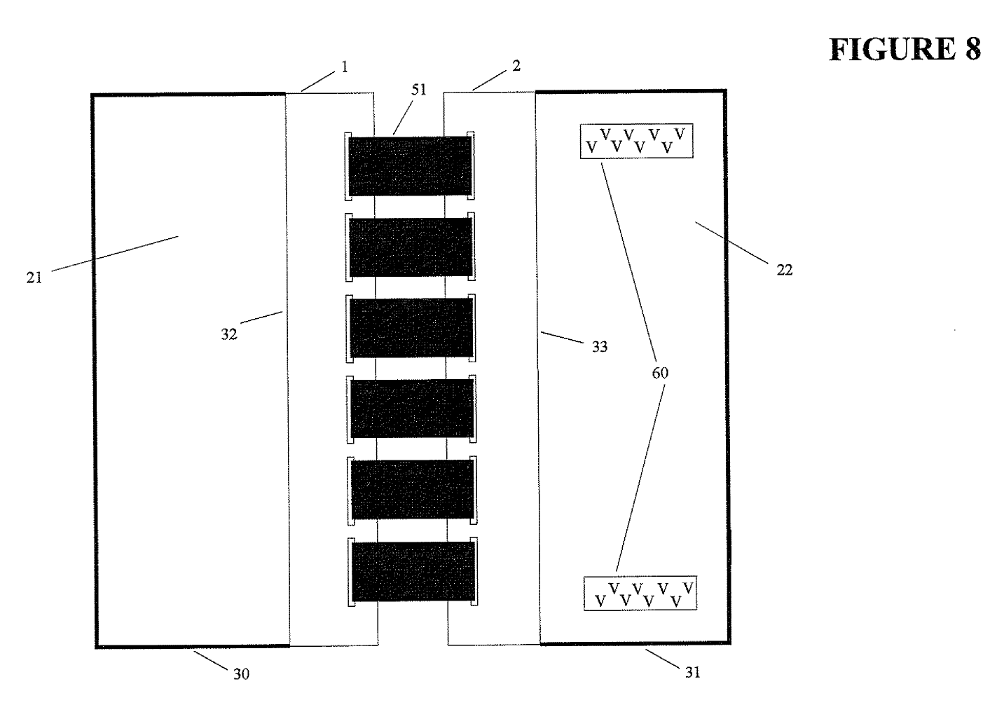

FIG. 8 serves to illustrate how the cover-leaf holders 21,22 are connected to the inner panels 1,2, and how the arrangement itself is held together as a single unit. The bold lines 30,31, correspond to the top, bottom and outer edges of the holders 21,22, and indicate the points at which the cover-leaf holders 21,22 and both inner and outer cover panels are stitched, stapled or otherwise joined together. The inner edges of the cover-leaf holders 32,33 are naturally left open and unstitched.

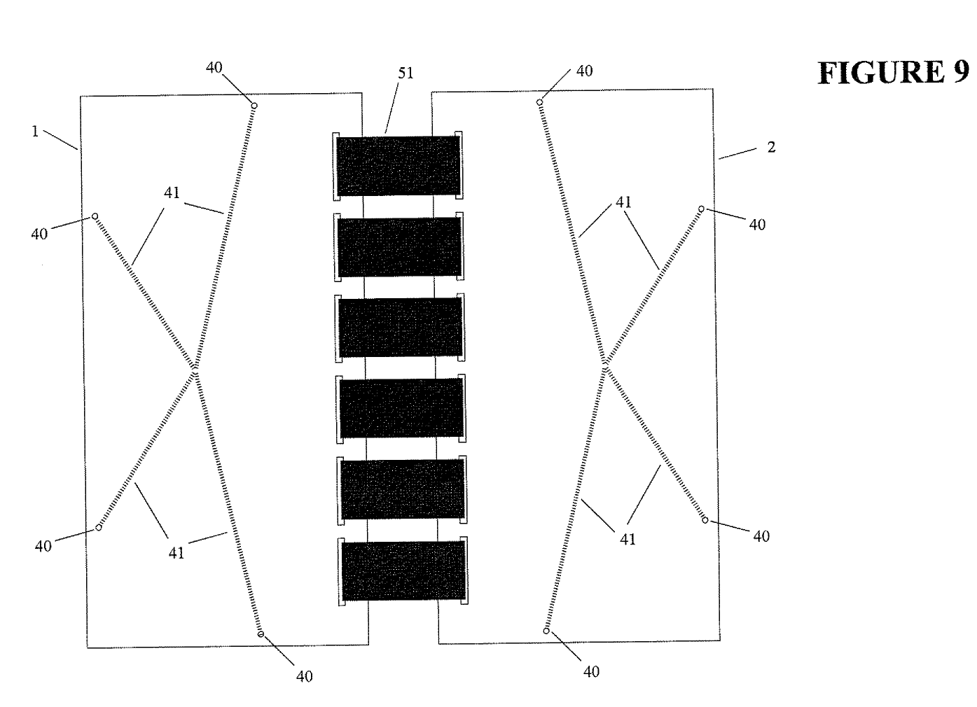

FIG. 9 shows an embodiment of the invention in which holes 40 are present in the cover panels 1,2. Through the holes 40 flexible cords 41 are laced. The cords 41 function as cover-leaf holders. It will be clear to the skilled person that other configurations for the cover-leaf holder are possible depending on the specific nature of the contents to be held.

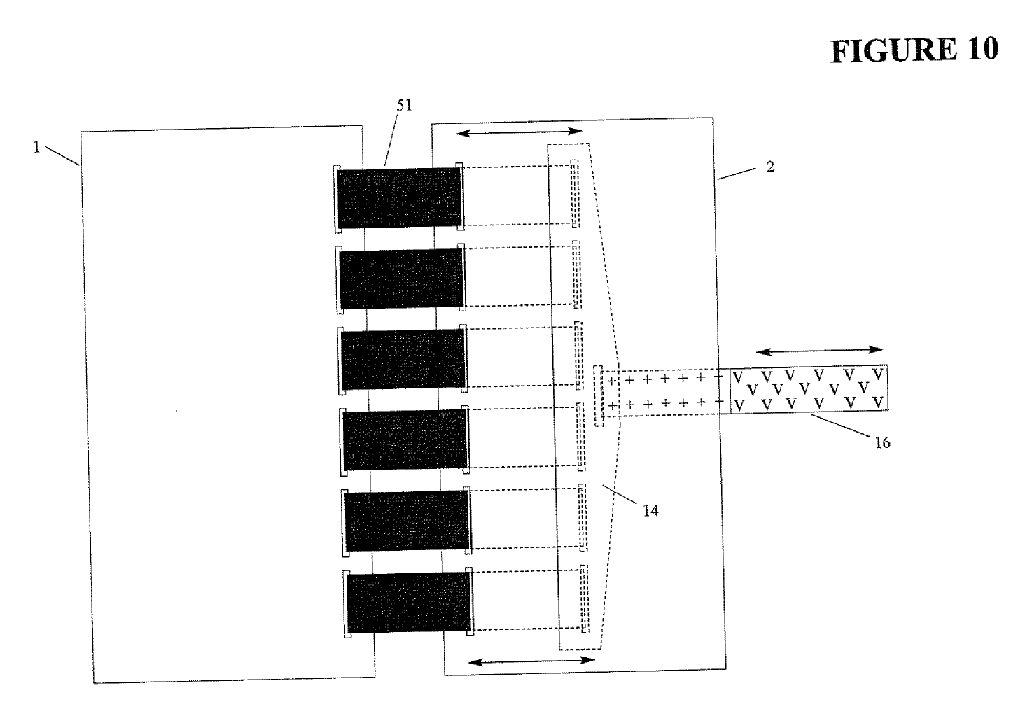

FIG. 10 schematically shows the possible movement of the thickness adjuster alongside one of the covers. By pulling the ribbon 16, a user can adjust the length of the bands 51 outside the cover, thereby varying the distance between the front and the back cover. It is noted that even in the situation in which the book or documents are already embraced by the cover arrangement, the user is still able to readjust the thickness.

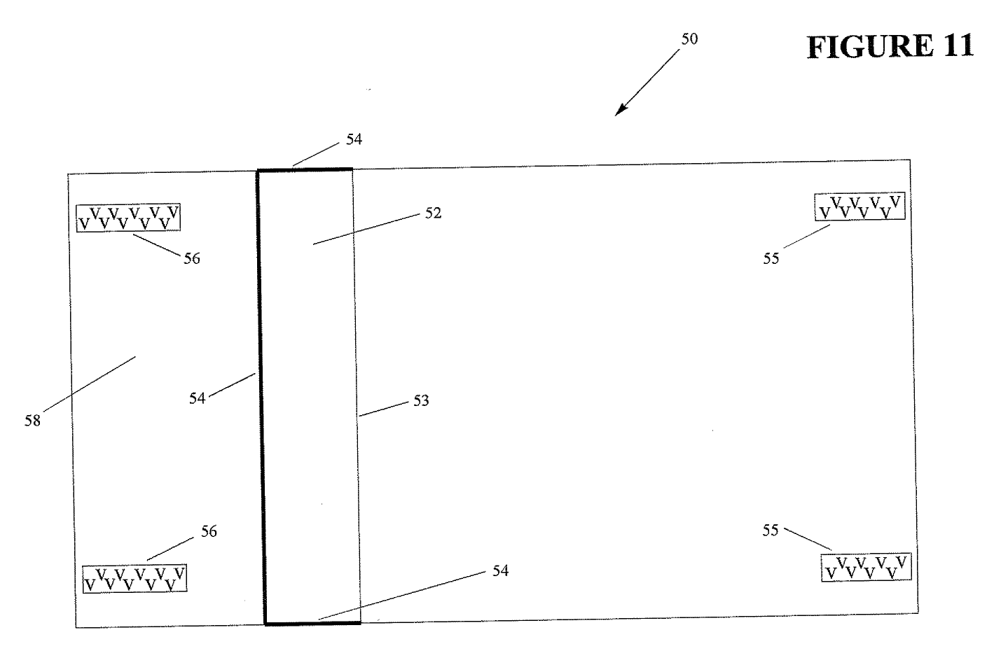

FIG. 11 shows the inside of a representative outer cover 50 according to an embodiment. The design encompasses a flexible rectangular sheet with a pocket 52 wherein the left edge of the frame is placed (see FIG. 12). The pocket 52 is left open on the inner edge 53 and stitched to the outer cover on the other three sides 54. The inside of the outer cover 50 also contains Velcro-type attachment points 55 for securing the right-hand side of the cover panels. The outer cover 50 may comprise a flap 58 which overlaps to fasten the outer cover closed by the Velcro attachment points 56.

FIG. 12 shows the frame (i.e. the cover panels with the connecting member) and the outer cover 50 prior to final assembly. The left-hand edge of the frame is inserted into the pocket 52 to complete the integrated system. FIG. 12 also shows Velcro-type attachment points 60 on the inner cover panel 2 on to which the Velcro-type attachment points 55 of the outer cover 50 are fastened.

For manufacturing the outer cover 50 (i.e. the outer fabric), vinyl may be used to produce robust outer covers, however lighter plastics and any number of other materials known to the skilled person may be used.

In an embodiment, the cover arrangement comprises a ring binder arranged on a separate sheet or possibly on one of the covers. The separate sheet can have slits through which the spine support bands 51 can be laced. The ring binder can be used to bind e.g. paper sheets.

It should be noted that the invention can be used to protect all kinds of media, including paper sheets and packets as well as books magazines and the like and many other types of essentially flat media including photos (thus creating a photo album), CDs and/or DVDs, personal organizers, agendas, a portfolio of artworks and potentially also ‘flat devices’ such as eBooks (electronic books), PDAs and even laptops.

While specific embodiments of the invention have been described above, it will be appreciated that the invention may be practiced otherwise than as described. The descriptions above are intended to be illustrative, not limiting. Thus, it will be apparent to one skilled in the art that modifications may be made to the invention as described without departing from the scope of the claims set out below.

1. A protective cover arrangement comprising:
a front cover;
a back cover; and
a connecting member for connecting said front cover to said back cover, said connecting member being arranged to adjust the distance between the front cover and the back cover.

2. The protective cover arrangement according to claim 1, wherein said connecting member comprises one or more flexible elements.

3. The protective cover arrangement according to claim 2, wherein said flexible elements comprise at least one of a band, a thread, a wire and a strand.

4. The protective cover arrangement according to claim 2, comprising at least one substantially rigid adjustment member movably arranged alongside said front and/or back cover, wherein said flexible elements are connectable to said adjustment members and/or an opposing cover.

5. The protective cover arrangement according to claim 4, wherein said flexible elements and/or said adjustment member are connectable to said front cover and/or said back cover.

6. The protective cover arrangement according to claim 5, wherein said flexible elements and/or said adjustment member are connectable to said front cover and/or said back cover by means releasable connecting means, such as Velcro tape.

7. The protective cover arrangement according to claim 4, comprising one or more fixing members for fixing said adjustment member into a fixed position alongside said cover.

8. The protective cover arrangement according to claim 7, wherein said fixing members comprise releasable connecting means, such as Velcro tape.

9. The protective cover arrangement according to claim 1, wherein said front cover and said back cover comprise a relatively rigid material.

10. The protective cover arrangement according to claim 1, wherein said front cover and said back cover have rectangular shapes.

11. The protective cover arrangement according to claim 1, wherein said front cover and/or said back cover comprise two panels.

12. The protective cover arrangement according to claim 1, wherein said front cover and/or said back cover comprise a rectangular shaped sheet material.

13. The protective cover arrangement according to claim 1, wherein said front cover and/or said back cover comprise one or more openings for attaching the connecting member.

14. The protective cover arrangement according to claim 1, wherein said cover comprises a replaceable outer cover.

15. A method of covering book-shaped media by means of an arrangement according to claim 1, said method comprising:
placing a front cover at a first side of said media;
placing a back cover at a second side of said media, opposite said first side;
connecting said front cover to said back cover by means of the connecting member; and
adjusting the length of the connecting member.
